(19) United States
(12) Patent Application Publication
(10) Pub. No.: US 2017/0134326 A1
(43) Pub. Date: May 11, 2017

(54) METHOD AND SYSTEM FOR SECURE TRANSMISSION AND RECEIPT OF AN ELECTRONIC MESSAGE

(71) Applicant: Giovanni Laporta, Watford (GB)

(72) Inventor: Giovanni Laporta, Watford (GB)

(21) Appl. No.: 15/344,621

(22) Filed: Nov. 7, 2016

Related U.S. Application Data
(60) Provisional application No. 62/251,985, filed on Nov. 6, 2015.
(60) Provisional application No. 62/374,958, filed on Aug. 15, 2016.

(51) Int. Cl. H04L 12/58; H04L 29/06; H04L 29/08

(52) U.S. Cl. CPC H04L 51/22; H04L 67/02; H04L 67/42; H04L 51/14

(57) ABSTRACT

What is provided is a method and system for securely transmitting and receiving electronic information over a computer network and for providing an indication of the transmission and receipt of the electronic information. The system comprises a sender computing device connected to a computer network; a recipient computing device connected to the computer network; and a web-based system that comprises an email server configured for receiving an email message having at least one actionable instruction, and for transmitting the content of the email message to the recipient computing device through the computer network after performing the actionable instruction. Prior to transmitting the email message to the recipient, the web-based system extracts the content from the sender's original message and inserts it into a separate electronic document that may be accessed by the recipient through a secure webpage.

### PRIORITY CLAIM

This patent application is a Non-Provisional patent application and claims priority under 35 U.S.C. 119(e) to U.S. Provisional Patent Application Ser. No. 62/251,985, titled “METHODS AND SYSTEMS FOR SECURE ELECTRONIC COMMUNICATION,” filed Nov. 6, 2015; and U.S. Provisional Patent Application Ser. No. 62/374,958, titled “METHOD AND SYSTEM FOR SECURE TRANSMISSION AND RECEIPT OF MAIL VIA ELECTRONIC COMMUNICATION,” filed Aug. 15, 2016. The entire disclosures of the aforementioned patent applications are incorporated by reference as if fully stated herein.

### FIELD

This patent application relates to methods and systems for securely transmitting and receiving messages and documents in the form of postal mail and email, and more particularly to a methods and systems for digitally sharing, reviewing, signing, and certifying messages and documents.

### BACKGROUND

In recent years, email communication has replaced traditional mail methods and practices since it is cheaper, faster, and usually more reliable. However, there are certain situations, such as registered and certified mail communications, where hard copy mailing is preferred over email. When a letter is sent by certified mail, the sender receives a receipt to prove that the letter was mailed. A return receipt provides evidence of successful delivery of the letter to the intended recipient. Similarly, private mail couriers, such as Federal Express® and United Parcel Service® (UPS) provide some type of delivery confirmation to the sender.

Existing email systems provide some form of proof that an email message was delivered to its intended recipient. For example, some email systems allow a sender to mark a message with “request for notifications” tags, which allow a sender to request notification that the message was delivered and/or opened. Upon requesting delivery notification, the web-based email system may provide the sender an email receipt that the message was delivered to the mail server or inbox of the recipient. The receipt message may include the title of the message, the recipient's address, and the time of delivery. Additionally, the recipient's email system may send to the sender an email notification that the recipient has opened the message.

However, email messages sent with notification requests may not be as effective as registered mail to prove actual delivery of a message in a court of law. In addition, email receipts in the form of email messages could have been altered, forged, or created by a third party. Thus, there exists a need for an email system and method that may provide reliable evidence to the sender of both the content and the delivery of an email message. In other words, the sender may want proof that the recipient responded to the message and of the content of that response.

Some email systems have mechanisms for a sender to receive verification from a third party web-based system that a message was successfully transmitted to an intended recipient. Other email systems use specific email clients or email plug-ins to notify senders when a message has been received. However, these email systems may require that both the sender and recipient use the same email client and/or that the both the sender and recipient upload and download files directly to a third party website. Thus, these email systems limit users to specific email clients or web-based software, which is limiting and burdensome. Another problem with current email client delivery verification (read receipt notifications) is cross-platform compatibility issues between computing devices and third party email software systems. In addition, these email systems do not conduct biometric identify verification and are often limited to simply informing the sender that an email message has been received, without offering the ability to perform any additional actions with regard to the messages and/or their content, such as storing, forwarding, retrieving, signing, etc.

Accordingly, there exists a need for an electronic communication system and method that can provide the following: (1) a more user-friendly reliable way of content authentication and delivery of electronic messages; (2) a higher level of identity verification, security, and privacy; (3) a system that does not require the registration of both the sender and the recipient; (4) a system that overcomes cross-platform compatibility issues; and (5) the ability to send electronic messages from predetermined email addresses that carry specific instructions to automatically perform various electronic actions and commands.

### SUMMARY

What is provided is a method and system for securely transmitting and receiving electronic information over a computer network and for providing an indication of the transmission and receipt of the electronic information. Specifically, a web-based system may be accessed via a computer network by at least one sender computing device and at least one recipient computing device. Each of the sender computing device and the recipient computing device has access to the computer network, thereby allowing a sender and a recipient to have access to the web-based system from nearly anywhere in the world.

In exemplary embodiments, the system for providing an indication of the transmission and receipt of an electronic message comprises a sender computing device connected to a computer network; a recipient computing device connected to the computer network; and a web-based system, the web-based system comprising: an email server configured for receiving a first email message sent from the sender computing device, the first email message comprising at least one actionable instruction, and for transmitting the content of the first email message to the recipient computing device through the computer network after performing the actionable instruction; at least one processor; and computer executable instructions readable by the processor and causing the web-based system to: allow a sender to register an account and create a user profile; allow the sender to select an email system for composing and sending the first email message; receive the first email message from the sender and perform the actionable instruction after recording the first email message in the web-based system; provide a first indication to the sender that the first email message was received by the web-based system and that the content of the first email message will be transmitted to a recipient; extract the content from the body of the first email message; generate an electronic document and insert the content extracted from the first email message into the electronic document; create a second email message, the second email message comprising a URL link directed to a webpage capable of displaying the electronic document, and transmit the second email message to the recipient via the computer network; and provide a second indication to the sender of the transmission and receipt by the recipient of the content from the first email message.

The web-based system allows for electronic information and data to be securely transmitted from the sender computing device to the recipient computing device. However, the first email message may be composed and sent from either the local network using the sender's everyday email system or through the website and the web-based system.

In exemplary embodiments, the computer-implemented method for providing an indication of the transmission and receipt of an electronic messages comprises using a sender computing device to allow a sender to register an account and create a user profile; allowing the sender to select an email system for composing and sending a first email message, the first email message comprising at least one actionable instruction; using an email server from a web-based system to receive the first email message and perform the actionable instruction; providing a first indication to the sender that the first email message was received by the email server and that the content of the first email message will be transmitted from the email server to the recipient; extracting the content from the body of the first email message using the web-based system; using the web-based system to generate an electronic document and insert the content extracted from the first email message into the electronic document; using the email server to create and transmit a second email message to the recipient, the second email message comprising a first URL link directed to a first webpage capable of displaying the electronic document; and providing a second indication to the sender of the transmission and receipt by the recipient of the content from the first email message.

### BRIEF DESCRIPTION OF THE DRAWINGS

Subject matter is particularly pointed out and distinctly claimed in the concluding portion of the specification. Claimed subject matter, however, as to structure, organization and method of operation, together with objects, features, and advantages thereof, may best be understood by reference to the following detailed description if read with the accompanying drawings in which:

FIG. 1 is an exemplary embodiment of a system for providing an indication of the transmission and receipt of an electronic message over a network using a web-based system;

FIG. 2 is an exemplary flow chart showing a method for composing, transmitting, and recording email through the web-based system;

FIG. 3 is an exemplary flow chart showing a method for verifying and authenticating the identify of a recipient using the online security measures of the web-based system;

FIG. 4 is a diagram of the landing page on the website showing an exemplary image of various formats of message delivery to the recipient computing device;

FIG. 5 is an exemplary image of a notification message being composed through the web-based system;

FIG. 6 is an exemplary image of an email confirmation message sent from the web-based system to the sender computing device;

FIG. 7 is an exemplary image of a notification message sent to the at least one recipient computing device; and

FIG. 8 is an exemplary image of an email message composed from a user's everyday email system containing plugins corresponding to the predetermined email addresses of the web-based system.

### DETAILED DESCRIPTION

In the following detailed description, numerous specific details are set forth in order to provide a thorough understanding of the examples as defined in the claimed subject matter, and as an example of how to make and use the examples described herein. However, it will be understood by those skilled in the art that claimed subject matter is not intended to be limited to such specific details, and may even be practiced without requiring such specific details. In other instances, well-known methods, procedures, and components have not been described in detail so as not to obscure the examples defined by the claimed subject matter.

Some portions of the detailed description that follow are presented in terms of algorithms and/or symbolic representations of operations on data bits and/or binary digital signals stored within a computing system, such as within a computer and/or computing system memory. An algorithm is here and generally considered to be a self-consistent sequence of operations and/or similar processing leading to a desired result. The operations and/or processing may take the form of electrical and/or magnetic signals configured to be stored, transferred, combined, compared and/or otherwise manipulated. It has proven convenient at times, principally for reasons of common usage, to refer to these signals as bits, data, values, elements, symbols, characters, terms, numbers, numerals and/or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing”, “computing”, “calculating”, “determining” and/or the like refer to the actions and/or processes of a computing platform, such as a computer or a similar electronic computing device that manipulates and/or transforms data represented as physical electronic and/or magnetic quantities and/or other physical quantities within the computing platform's processors, memories, registers, and/or other information storage, transmission, and/or display devices.

Unless specifically stated otherwise, as apparent from the following discussion, it is appreciated that throughout this specification a computing platform includes, but is not limited to, a device such as a computer or a similar electronic computing device that manipulates and/or transforms data represented by physical, electronic, and/or magnetic quantities and/or other physical quantities within the computing platform's processors, memories, registers, and/or other information storage, transmission, reception and/or display devices. Accordingly, a computing platform refers to a system, a device, and/or a logical construct that includes the ability to process and/or store data in the form of signals. Thus, a computing platform, in this context, may comprise hardware, software, firmware and/or any combination thereof. Where it is described that a user instructs a computing platform to perform a certain action, it is understood that “instructs” may mean to direct or cause to perform a task as a result of a selection or action by a user. A user may, for example, instruct a computing platform embark upon a course of action via an indication of a selection, including, for example, pushing a key, clicking a mouse, maneuvering a pointer, touching a touch pad, touching a touch screen, acting out touch screen gesturing movements, maneuvering an electronic pen device over a screen, verbalizing voice commands, and/or by audible sounds. A user may include an end-user.

Flowcharts, also referred to as flow diagrams by some, are used in some figures herein to illustrate certain aspects of some examples. Logic they illustrate is not intended to be exhaustive of any, all, or even most possibilities. Their purpose is to help facilitate an understanding of this disclosure with regard to the particular matters disclosed herein. To this end, many well-known techniques and design choices are not repeated herein so as not to obscure the teachings of this disclosure.

Throughout this specification, the term “system” may, depending at least in part upon the particular context, be understood to include any method, process, apparatus, and/or other patentable subject matter that implements the subject matter disclosed herein. The subject matter described herein may be implemented in software, in combination with hardware and/or firmware. For example, the subject matter described herein may be implemented in software executed by a hardware processor.

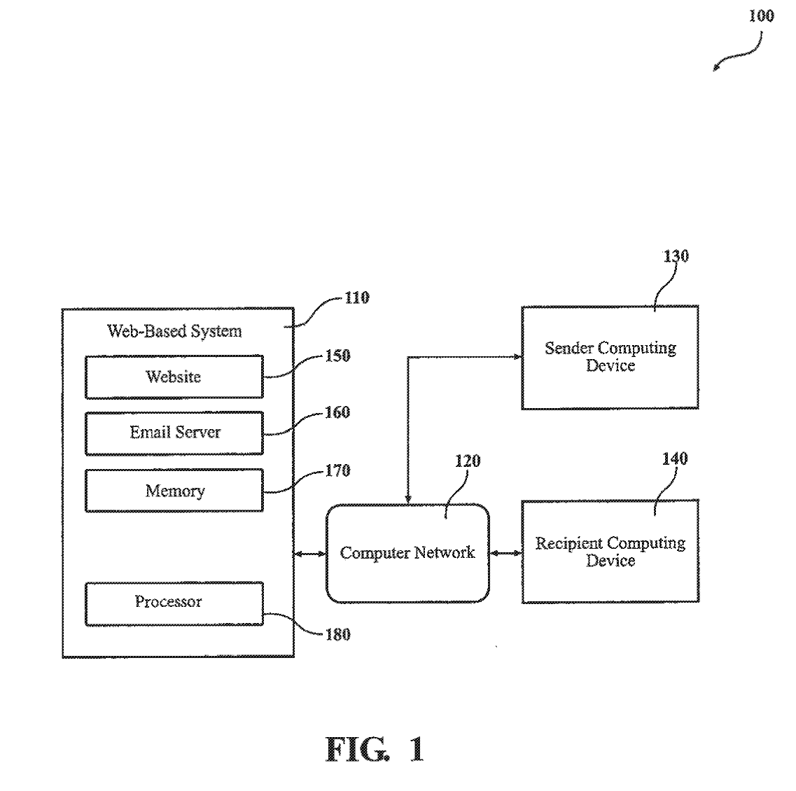

Referring to FIG. 1, FIG. 1 shows an exemplary embodiment of a system 100 for providing an indication of the transmission and receipt of an electronic message over a network 120 using a web-based system 110. Specifically, the web-based system 110 may be accessed via a computer network 120, such as the World Wide Web, by at least one sender computing device 130 and at least one recipient computing device 140. The sender computing device 130 and recipient computing device 140 each have access to the computer network 120, thereby allowing a sender and/or a recipient to have access to the web-based system 110 from nearly anywhere in the world. The sender computing device 130 and the recipient computing device 140 may each be a personal computer, notebook computer, server computer, personal digital assistant, cellular phone, handheld device, or any other functionally equivalent device. In some embodiments, the web-based system 110 may be known as DID YOU GET MY MAIL™.

The web-based system 110 comprises a website 150, an email server 160, a memory 170, and at least one processor 180. The email server 160 is associated with the website 150. The website 150 allows for the display and exchange of information between the sender computing device 130, the recipient computing device 140, and the web-based system 110. In addition, the sender may visit the website 150 to compose his message by entering the desired “to,” “cc,” “bcc,” “Subject,” and message body information. The recipient may reply to the sender's message using the website 150 and both the sender and recipient may use the website 150 to securely review, share, and sign documents.

The processor 180 is used for carrying out the functions of the web-based system 110 and the memory 170 may store and provide the instructions for the processor 180 to transmit and authenticate electronic messages, data, and files over the computer network 120. The email server 160 is used for receiving, tracking, managing, and transmitting email messages and files over the computer network 120. The web-based system 110 may perform a variety of functions to allow users to securely transmit and authenticate electronic messages, data, and files over the computer network 120 as discussed below.

In some examples, users of the web-based system 110 may compose and send recorded mail directly from any commonly used emailing software system, such as OUTLOOK®, HOTMAIL®, GMAIL®, etc., while the recorded mail is still being securely transmitted to at least one intended recipient through the web-based system 110. The recorded mail may be sent from the sender computing device 130, which may be a personal computer, notebook computer, server computer, personal digital assistant, cellular phone, handheld device, or any other functionally equivalent device known in the art. In other examples, users may compose and send recorded mail exclusively through the web-based system 110. As such, the sender may either select and register a unique predetermined email address generated by the web-based system 110 or elect to have the web-based system 110 select the predetermined email address for the sender.

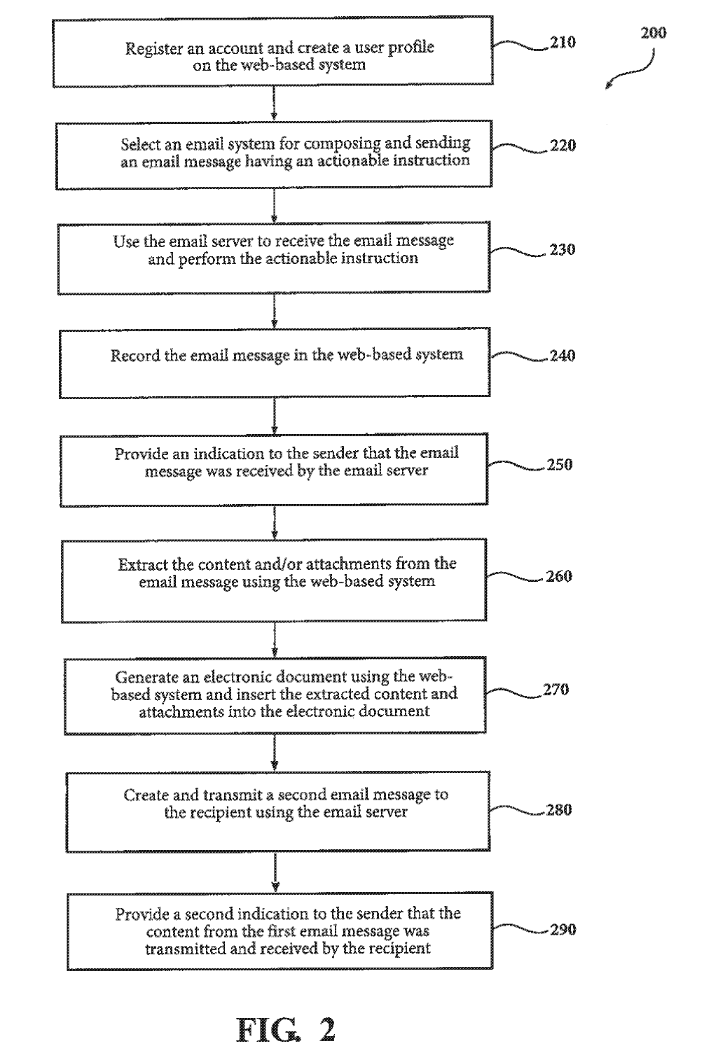

Referring to FIG. 2, FIG. 2 is an exemplary flow chart showing a method 200 for composing, transmitting, and recording email through the web-based system 110. As shown in block 210, after registering an account and creating a user profile with the web-based system 110, the user accesses the various features and functions of the web-based system 110 using the sender computing device 130 and/or the recipient computing device 140. The user then selects an email system for composing and sending an email message, as shown in block 220. The sender can either use his local, everyday email system or the email system of the web-based system 110. Messages transmitted through the sender's everyday email system will be transmitted through the sender's local network. If the sender elects to use the web-based system 110, the web-based system 110 functions as the sender's outgoing mail server.

As shown in block 230, the email server 160 is configured to receive email messages from the sender and perform an actionable instruction embedded in the email message. Specifically, the web-based system 110 starts performing an action, such as recording email, based on the instruction/command found in the Domain Name ITS protocol. Each email message received by the email server 160 comprises a predetermined email address that carries specific instructions and/or commands to automatically execute various electronic tasks. In some embodiments, the predetermined email address is generated by the web-based system 110 and chosen by the sender. In other embodiments, the web-based system 110 generates and assigns the predetermined email address to the sender. In addition, each predetermined email address comprises a unique identifier assigned by the web-based system 110 that can be recognized and processed by the email server 160. In some examples, the unique identifier includes the sender's individual name or entity name. After processing the specific instructions and/or commands, along with the unique identifier, the email server 160 performs the desired action requested by the sender. In some embodiments, an actionable instruction sent to the email server 160 may be known as a Domain Name Instruction to Server (ITS) protocol.

The ITS protocol is an algorithm to execute a particular function, such as to record a user's email. The Domain Name ITS protocol is formatted as an email address and may be included in either the “From” or “To” sections of a message header that is sent to the web-based system 110. An example of the Domain Name ITS protocol included in the “To” section of a message is recordmy@traverselegal.email. An example of the Domain Name ITS protocol included in the “From” section of a message is recordmymail@didyougetmymail.com. While the actionable instructions included in the “To” section of a message is unique and specific for a particular user, such as Traverse Legal, the Domain Name ITS protocols included in the “From” section of a message are not specific for a particular user and can therefore be used by a plurality of third parties. The web-based system 110 is capable of associating the actionable instructions included in the “From” section of a message with a particular user based on the user's unique login information and password. Also, actionable instructions included in the “From” section of a message provide the sender with an unlimited file size attachment quota. As a result, users may store and transmit more attachments included in the message than with a user's everyday email system.

In the recordmy@traverselegal.email (found in the “To” section of a message) example, the actionable instructions (Domain Name ITS protocol) notifies the web-based system 110 that the email message needs to be recorded for this specific registered user of the web-based system 110, known as Traverse Legal in this example. In the recordmy@traverselegal.email example, the email server 160 interprets and processes the actionable instruction in the Domain Name ITS protocol as “Record My Traverse Legal Email.” The web-based system 110 automatically stores all electronic messages and documents in the sender's user account within the web-based system 110. The email address of the intended recipient of the email message may be listed in the carbon copy (“CC”) section of the message header, while additional email addresses of third party recipients may be included through the blind carbon copy “BCC” section of the message header.

As shown in block 240, the email message is recorded in the web-based system 110 after being received by the email server 160. In some embodiments, the email message is transmitted for recording by a third party database in communication with the web-based system 110. In some embodiments, third party database may be Blockchain™. The third party database prevents the falsifying of information and data in the web-based system 110 since only the information and data that was originally received can be accessed and this information and data can never be changed. The email server 160 interprets and processes the actionable instructions and/or commands provided in the Domain Name ITS protocol. As a result, block 240 of the method 200 is comparable with and applicable to the sender requesting a postal office to provide a record of delivery of the mail through a return receipt request.

As shown in block 250, the email server 160 provides an indication to the sender that the email has been received by the web-based system 110. The web-based system 110 provides the sender with a time-stamped receipt that the email message was accepted by the web-based system 110 and an acknowledgement that the content of the email message will be sent to the desired recipient by recorded delivery email. In some embodiments, the email message may be tagged by the web-based system 110 to denote the fact that the email message has been made of record, such as by inserting words at the beginning of the subject line of the email message. Examples of such words may be “This message has been recorded using DID YOU GET MY MAIL™.

As shown in block 260, the web-based system 110 extracts the content included in the body of the email message and any attachments found in the email message sent from the sender computing device 130. The web-based system 110 may extract the content and any attachment prior to performing an action based on the instructions in the Domain Name ITS protocol or after performing an action based on the instructions in the Domain Name ITS protocol.

In block 270, the web-based system 110 generates an electronic document and inserts the extracted content and attachments into the electronic document. In some examples, the newly-generated electronic document is known as the Electronically Sealed Document (ESD)™. The electronic document is then forwarded to the email server 160, which processes the document and automatically generates a unique pin number specifically associated with this document. The email server 160 also adds a virtual seal to this newly-generated electronic document.

In block 280, the web-based system 110 creates a second email message and embeds the unique pin number, which is associated with the newly-generated electronic document, into the body of the newly composed email message as a URL link directed to the website 150. The web-based system 110 then transmits the new email message to the recipient using a predefined email address for the desired recipient found in the web-based system 110 and awaits for the recipient to accept the invitation to click on the URL link found in the email message. Instead of merely transmitting the original email and its text and attachments from the sender straight through a commonly used mail server found on the recipient computing device 140, the web-based system 110 alters the flow of the email transmission process. By reading and processing the actionable instructions and/or commands found in the Domain Name ITS protocol, the web-based system 110 can provide the sender with confirmation of transmission and delivery of the email message to its intended recipient. Also, the web-based system 110 provides additional levels of privacy protection and security to the content on any emails transmitted through the web-based system 110.

Once the recipient accepts the invitation to click on the URL link transmitted to the recipient computing device 140, the recipient is re-directed online to a webpage on the web-based system 110, where the recipient may access and review the newly-generated electronic document. As a result, the recipient may view the full content, and accompanying attachments, of the original message transmitted from the sender computing device 130. The content of the email message may be opened in a variety of electronic formats. In some examples, the electronic format is PDF® viewer. Once the recipient opens the newly-generated electronic document, the web-based system 110 records and stores such information as:
a) the date and time at which the recipient accessed the webpage on the web-based system 110 through the URL link;
b) the date and time at which the recipient opened the newly-generated electronic document;
c) the content of the original message together with any attachments included in the original message; and
d) the Domain Name ITS protocol.
   In other examples, the recipient may copy and paste the URL link into a web browser on the recipient computing device 140. In addition to being able to read the content of the message transmitted from the sender computing device 130, the recipient can send a reply to the message through the web-based system 110. Block 280 is comparable with and applicable to the recipient accepting and signing for postal mail in order allow the postal/courier service to provide proof of delivery to the sender.

In block 290, once the recipient opens the newly-generated electronic document, the email server 160 automatically transmits to the sender an indication of the successful transmission and receipt by the recipient of the content in the email message. Also, the email server 160 provides to the sender the content of any reply to the sender's original message made by the recipient. Block 290 is comparable with and applicable to the sender receiving delivery and read receipt confirmations produced by the postal/courier service.

For security reasons, the electronic document containing the content of the message and any attachments may only be available on the web-based system 110 for a predetermined amount of time after it has been opened by the recipient. Using the web-based system 110, several features may be performed on the message content, including, but not limited to refreshing the content, sharing the content, and signing the document. All email messages sent through the web-based system 110 will be routed through the email server 160 and allow the web-based system 110 to certify that an email message was both transmitted and received by its intended recipient. The web-based system 110 provides a time and date stamp for each message and tracking and recording the same.

The recipient may respond to the sender's message by clicking on a “Reply” button in the web-based system 110. In the message header, the email server 160 identifies the sender's first name and predetermined email address used in the original email message. In some embodiments, the recipient may respond by using his/her own everyday email address. In other embodiments, the recipient may respond by selecting from a list of predetermined internal email address generated by the web-based system 110. Regardless of the email address that the recipient selects to reply with, the recipient has the option to become a registered user of the web-based system 110 and respond directly to the sender through the email server 160 using the computer network 120. In an alternative embodiment, the recipient may simply print a hard copy of the message and reply to it directly through postal mail.

After the recipient accesses the webpage displaying the electronic document comprising the content and/or attachments of the original message, the sender receives an automatic confirmation message from the web-based system 110 that the notification email message was delivered to the intended recipient and opened. The confirmation message comprises a URL that the sender can click on to obtain a mail receipt and to review specific information regarding the delivery of the message to the recipient. The sender will then be prompted to proceed through the same type of online URL security process as the recipient. In some embodiments, the sender can review specific content and data tracked by the email server 160 regarding the travelled path of the message to the recipient, such as the time at which the message was received, the number of recipients on the message, names of the attachments included on the message, the internet address of the recipients, the names of the sender and recipient, the size of the message, the type of message, the specific conditions of delivery, and/or other information of the recipient.

The web-based system 110 allows for messages with unlimited file size to be sent, as compared with sending message through personal/local email systems. By using the “From” section of an email message, the sender can transmit messages containing documents and files having much larger sizes through the email server 160 of the web-based system 110, as compared to messages sent through a sender's everyday email system. Once a sender obtains the access code in the message or signs in to his/her account, the web-based system 110 recognizes and associates the at least one sender computing device 130 with the web-based system 110.

The sender may determine the extent and type of confirmation that he/she intends to receive from the web-based system 110 upon delivery of a message to the at least on recipient's computing device 140. Examples of the types of confirmation that the sender may receive from the web-based system 110 include a receipt message confirming that the sender's message delivered to its intended recipient(s) and/or proof of the recipient(s) digital signature on a specific document.

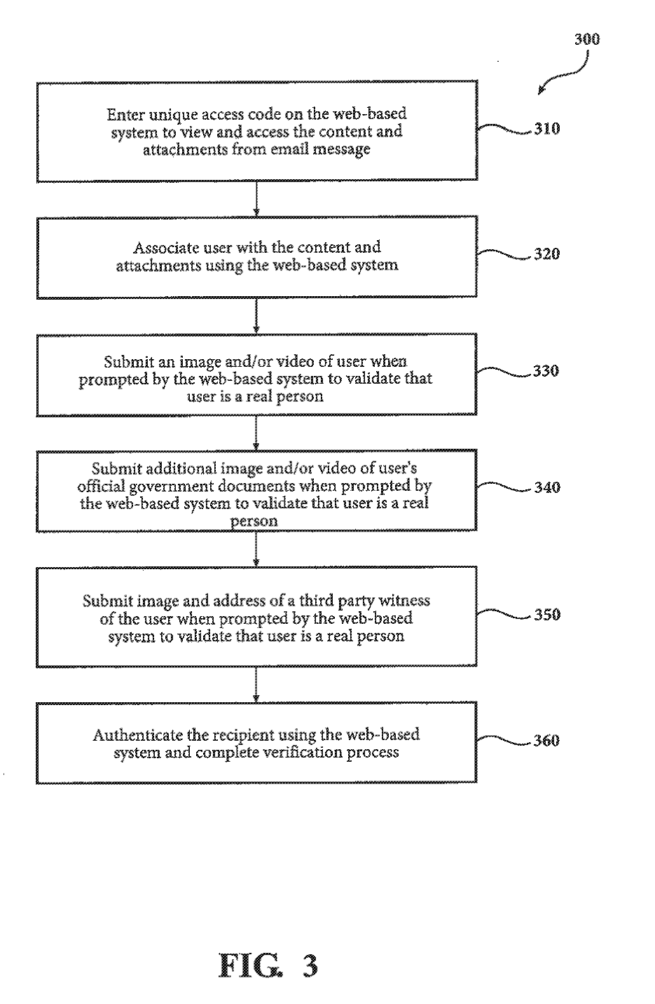

Referring to FIG. 3, FIG. 3 shows an exemplary flow chart showing a method 300 for verifying and authenticating the identity of a recipient using the online security measures of the web-based system 110. In some examples, the recipient may be required to proceed through additional levels of online security, besides the unique access code included in the notification message, prior to viewing the content and attachments in the sender's email message, as shown in block 310. These additional levels of online security may involve biometric identity verification processes and/or process used to determine the geographic location of the sender computing device 130 and the recipient computing device 140. A location determination device coupled to the processor 180, such as a GPS module, WiFi positioning module, cellular positioning module, and the like may be used to verify the location of the sender computing device 130 and the recipient computing device 140.

Upon clicking on the URL link and entering the access code in the appropriate location on the website 150, the email server 160 associates the recipient with the content of the message and its attachments, as shown in block 320. In addition to entering the access code, the biometric features of the web-based system 110 may be activated. Specifically, the web-based system 110 may require the recipient of a message or document to provide his/her digital signature and/or approval to the same prior to viewing the content of the sender's original message.

In block 330, in some examples, the recipient may submit an image and/or video clip of himself when prompted by the web-based system 110 to validate that the user is a real person. The recipient may also be required to submit additional photographs to the web-based system 110 from various official government documents, such as, but not limited to passport, driver's licenses, and birth certificates, as shown in block 340. Images from these documents may be scanned directly into the web-based system 110. The web-based system 110 may then validate that the recipient is a real person, instead of a photograph, prerecorded video, or an avatar.

In some embodiments, the recipient may also be required to provide additional verification through a photo and address of a third-party witness, as shown in block 350. If the recipient is verified through the security measures, then the web-based system 110 may authenticate and complete the verification process of the recipient, as shown in block 360. The sender and or the web-based system 110 may determine the extent, type, and amount of the online security/biometric identity verification measures that the recipient must undergo in order to access the content of the message or its attachments.

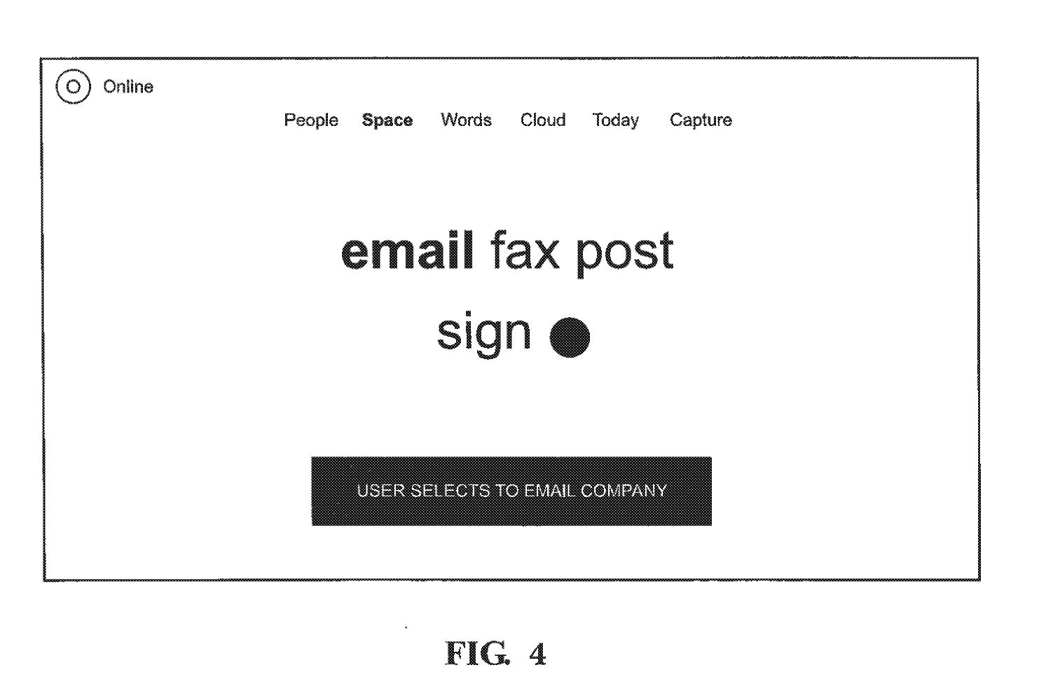

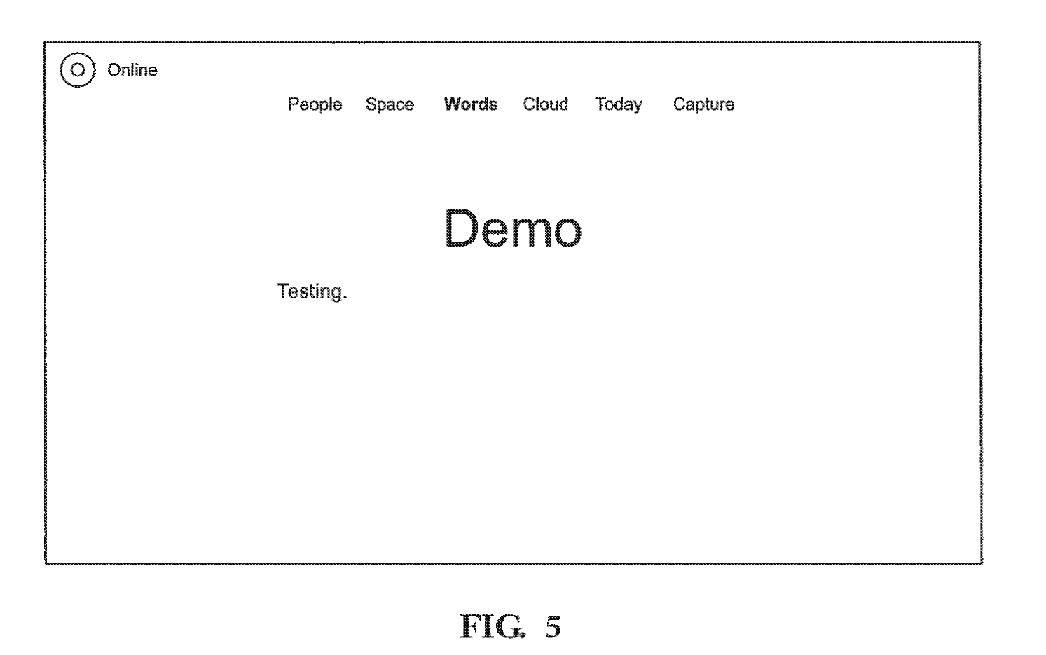

Referring to FIG. 4, FIG. 4 shows a diagram of the landing page on the website 150 showing an exemplary image of various formats of message delivery to the recipient computing device 140. Referring to FIG. 5, FIG. 5 shows an exemplary image of a notification message being composed through the web-based system 110.

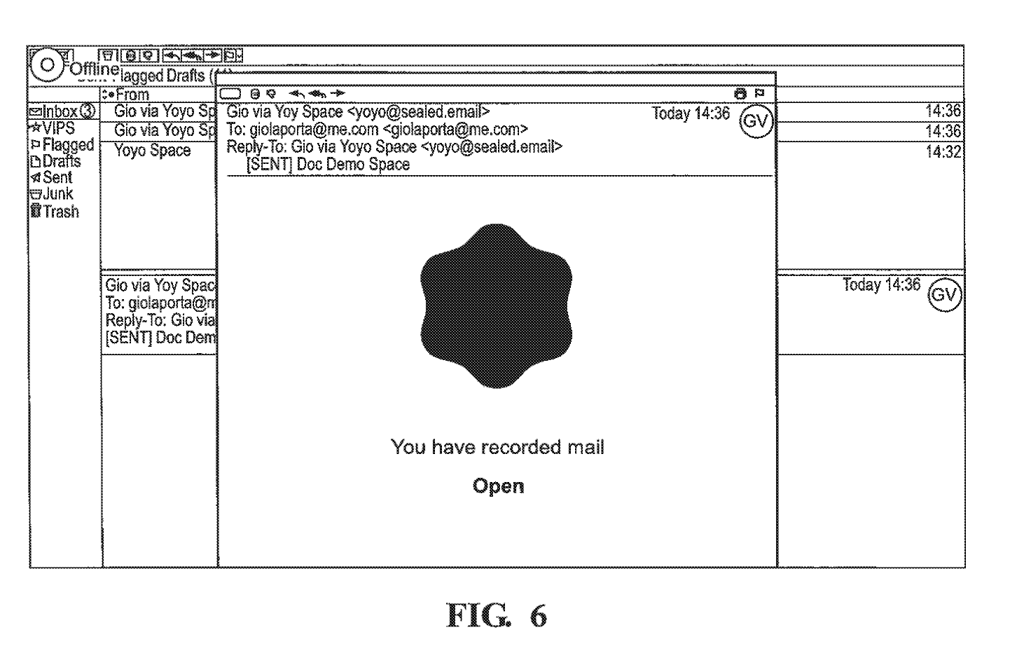

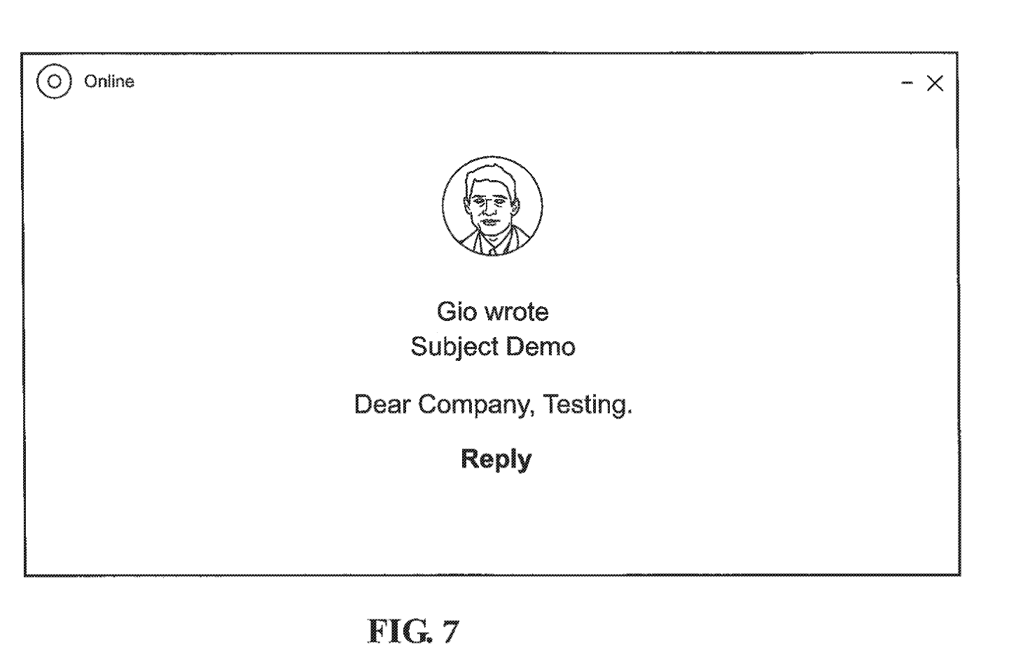

Referring to FIG. 6, FIG. 6 shows an exemplary image of an email message sent from the web-based system 110 to the sender computing device 130 after a notification message has been sent to the recipient computing device 140. Referring to FIG. 7, FIG. 7 shows an exemplary image of the notification message sent to the recipient computing device 140 so that the recipient may view the content of the notification message and its attachments through the web-based system 110.

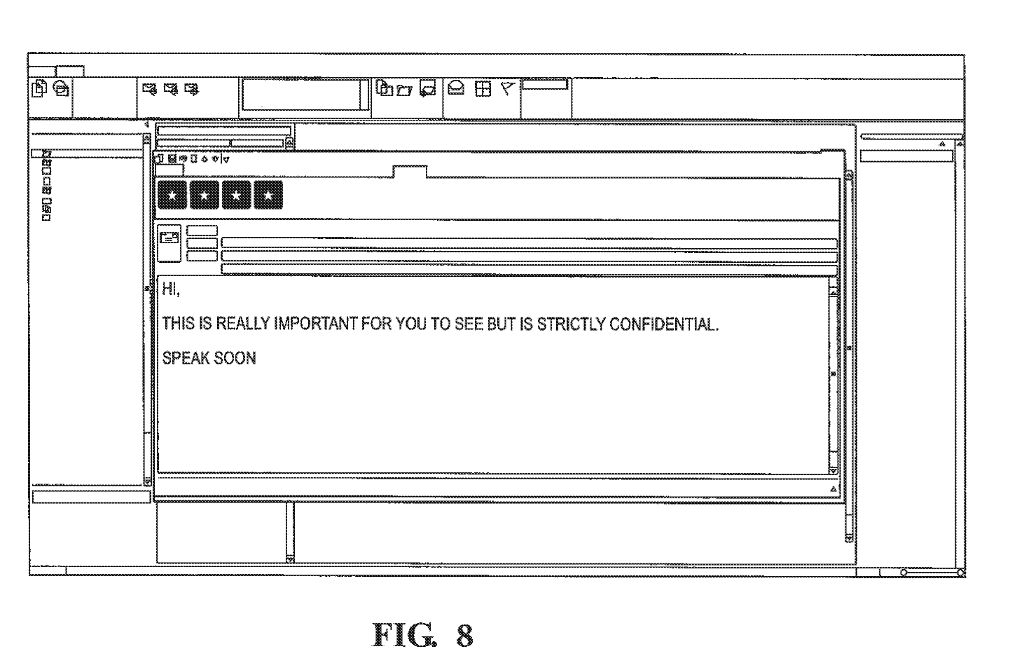

Referring to FIG. 8, FIG. 8 shows an exemplary image of an email message composed from a user's everyday email system containing plugins corresponding to the predetermined email addresses of the web-based system 110.

It will, of course, be understood that, although particular embodiments have just been described, the claimed subject matter is not limited in scope to a particular embodiment or implementation. Likewise, an embodiment may be implemented in any combination of systems, methods, or products made by a process, for example.

In the preceding description, various aspects of claimed subject have been described. For purposes of explanation, specific numbers, systems, and/or configurations were set forth to provide a thorough understanding of claimed subject matter. Computer file types and languages, and operating system examples have been used for purposes of illustrating a particular example. However, it should be apparent to one skilled in the art having the benefit of this disclosure that claimed subject matter may be practiced with many other computer languages, operating systems, file types, and without these specific details. In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that claims are intended to cover all such modifications or changes as fall within the true spirit of claimed subject matter. Modifications and substitutions by one of ordinary skill in the art are considered to be within the scope of the present disclosure.

1. A system for providing an indication of the transmission and receipt of an electronic message comprising:
a sender computing device connected to a computer network;
a recipient computing device connected to the computer network; and
a web-based system, the web-based system comprising:
an email server configured for receiving a first email message sent from the sender computing device, the first email message comprising at least one actionable instruction, and for transmitting the content of the first email message to the recipient computing device through the computer network after performing the actionable instruction;
at least one processor; and
computer executable instructions readable by the processor and causing the web-based system to:
allow a sender to register an account and create a user profile;
allow the sender to select an email system for composing and sending the first email message;
receive the first email message from the sender and perform the actionable instruction after recording the first email message in the web-based system;
provide a first indication to the sender that the first email message was received by the web-based system and that the content of the first email message will be transmitted to a recipient;
extract the content from the body of the first email message;
generate an electronic document and insert the content extracted from the first email message into the electronic document;
create a second email message, the second email message comprising a URL link directed to a webpage capable of displaying the electronic document, and transmit the second email message to the recipient via the computer network; and
provide a second indication to the sender of the transmission and receipt by the recipient of the content from the first email message.

2. The system of claim 1, the first email message is composed and sent from the sender's local email system.

3. The system of claim 1, the first email message is composed and sent from the web-based system's email system.

4. The system of claim 1, the first email message includes a predetermined email address generated by the web-based system, the predetermined email address comprises the actionable instruction and a unique identifier associated with the sender.

5. The system of claim 4, the predetermined email address is included in the “From” section of the first email message.

6. The system of claim 4, the predetermined email address is included in the “To” section of the first email message.

7. The system of claim 1, the web-based system further extracts attachments included with the first email message.

8. The system of claim 1, the web-based system automatically provides the second indication to the sender after the recipient accesses the webpage capable of displaying the electronic document.

9. A computer-implemented method for providing an indication of the transmission and receipt of an electronic message, the method comprising:
using a sender computing device to allow a sender to register an account and create a user profile;
allowing the sender to select an email system for composing and sending a first email message, the first email message comprising at least one actionable instruction;
using an email server from a web-based system to receive the first email message and to perform the actionable instruction;
providing a first indication to the sender that the first email message was received by the email server and that the content of the first email message will be transmitted from the email server to the recipient;
extracting the content from the body of the first email message using the web-based system;
using the web-based system to generate an electronic document and to insert the extracted content into the electronic document;
using the email server to create and transmit a second email message to the recipient, the second email message comprising a first URL link directed to a first webpage capable of displaying the electronic document; and
providing a second indication to the sender of the transmission and receipt by the recipient of the content from the first email message.

10. The computer-implemented method of claim 9, the first email message is composed and sent from the sender's local email system.

11. The computer-implemented method of claim 9, the first email message is composed and sent from the web-based system's email system.

12. The computer-implemented method of claim 9, the first email message includes a predetermined email address generated by the web-based system, the predetermined email address comprises the actionable instruction and a unique identifier associated with the sender.

13. The computer-implemented method of claim 12, the predetermined email address is included in the “From” section of the first email message.

14. The computer-implemented method of claim 12, the predetermined email address is included in the “To” section of the first email message.

15. The computer-implemented method of claim 9, providing a second indication to the sender after the recipient accesses the first webpage capable of displaying the electronic document.

16. The computer-implemented method of claim 15, the second indication provided to the sender comprises a second URL link directed to a second webpage capable of displaying information pertaining to the delivery of the content of the first email message to the recipient.

17. The computer-implemented method of claim 16, the information pertaining to the delivery of the content of the first email message to the recipient is one or more of the following: a receipt message confirming that the first email message was delivered to the recipient, a time and date that the recipient accessed the content from the first email message, a digital signature of the recipient, a name of an attached file included on the first email message, names of the sender and recipient on the first email message, size of the first email message, content of a reply transmitted by the recipient through the web-based system, and data related to a reply transmitted by the recipient through the web-based system.

18. The computer-implemented method of claim 9, the method further comprising: verifying the geolocation of the recipient using a location determination device on the web-based system prior to allowing the recipient to view the electronic document on the first webpage.

19. The computer-implemented method of claim 9, the method further comprising: verifying the digital signature of the recipient using the web-based system prior to allowing the recipient to view the electronic document on the first webpage.

20. The computer-implemented method of claim 9, the method further comprising: validating that the recipient is a real person from the submission of an image and/or a video by the recipient to the web-based system prior to allowing the recipient to view the electronic document on the first webpage, the image and/or the video is of the recipient, the recipient's official government documents, and/or a third-party witness of the recipient.
